(19) United States
(12) Patent Application Publication
(10) Pub. No.: US 2026/0164392 A1
(43) Pub. Date: Jun. 11, 2026

(54) SYSTEMS AND METHODS FOR RESPONDING TO REQUEST CAPABILITY MESSAGES IN CONTROL PLANE CALLS

(71) Applicant: Samsung Electronics Co., Ltd., Suwon-si, Gyeonggi-do (KR)

(72) Inventors: Gayathri KADABA SRINIDHI, San Jose, CA (US); Lalit ARORA, Fremont, CA (US); Taejin KIM, Hwaseong-si (KR); SangHyeon HAN, Hwaseong-si (KR)

(21) Appl. No.: 19/075,781

(22) Filed: Mar. 10, 2025

Related U.S. Application Data
(60) Provisional application No. 63/729,954, filed on Dec. 9, 2024.

(51) Int. Cl. H04W 64/00; H04L 5/00; H04W 8/22

(52) U.S. Cl. CPC H04W 64/00; H04L 5/0053; H04W 8/22

(57) ABSTRACT

Systems and methods are disclosed for location management. The systems and methods include sending, to an integrated circuit of a user equipment (UE), a request for first position information based on the UE receiving a request from a core network or a base station associated with a core network of the UE; determining that the request for the first position information times out based on receipt of the first position information being in a pending state when a timer expires; determining, based on the request for the first position information timing out, second position information different from the first position information; and sending a response message to the base station, the response message comprising the second position information.

### CROSS-REFERENCE TO RELATED APPLICATION

This application claims the priority benefit under 35 U.S.C. § 119(e) of U.S. Provisional Patent Application Ser. No. 63/729,954, filed Dec. 9, 2024, the disclosure of which is incorporated by reference in its entirety as if fully set forth herein.

### TECHNICAL FIELD

The disclosure generally relates to wireless technologies. More particularly, the subject matter disclosed herein relates to increasing reliability in responding to request capability messages in relation to control plane calls (e.g., E911 calls).

### SUMMARY

The long-term evolution (LTE) Positioning (LPP) protocol can include a protocol used to exchange location information across the User Equipment (UE) and the network in LTE networks, as well as 5G networks, 6G networks, etc. LPP supports multiple positioning methods: Enhanced Cell ID (ECID), Observed Time Difference of Arrival (OTDOA), Advanced Global Navigation Satellite System (AGNSS), Network Resource Identifier (NRECID) and other related 5G positioning methods. LPP can be used in Emergency (E911) calls. LPP can enable one or more types of calls. For example, LPP can enable Control Plane (CP) calls and/or User Plane (UP) calls. LPP may be defined by a sequence of procedures (a set of message transfers) between a User Equipment (UE) and the network. For CP calls, such messages may be exchanged between a modem and the Network entity (e.g., Enhanced Serving Mobile Location Center (E-SMLC)).

Protocols for mobile telecommunications can include capability transfer, assistance data transfer, and/or location exchange. Capability transfer can include a process that allows a UE to communicate its capabilities to a network. Capability transfer can help the network optimize the connection and provide the best user experience. Assistance data transfer can include the process of sending information from a network to a UE to enable the UE to perform tasks, such as positioning, signal quality assessment, etc. The information can include satellite ephemeris data, radio quality measurements, etc. Location exchange allows access networks to share location information with the core network. Location exchange information can be used to determine the location of the UE.

With some systems, upon reception of a Request Capability message from the network, the modem (e.g., modem chip) of a UE may check if capability data pertaining to AGNSS has been requested. If so, then the modem may pass on this request to a GNSS chipset, requesting capability info for AGNSS. Upon receiving the response message from the GNSS chip, the modem may encapsulate the requested information with the capability information of any other requested positioning methods (e.g., after mapping the requested information to a support list and sending a response back to the network).

In some cases, issues can arise when the GNSS core is down and the capability response for AGNSS is not received at the modem. For some systems, when the protocol associated with the Request Capability message does not define a response time for the UE to reply to this request, a cutoff time may not be configured or may not exist for the Request Capability message from the network. Hence, the modem may continue to wait indefinitely for the AGNSS Capability response from the GNSS chip and, as a result, may not share capability information for other positioning methods either, even when alternative information from other positioning methods may be readily available via the modem, owing to the policy that capability information for all the requested positioning methods in the received Downlink message with a particular transaction ID, must be responded to, by the UE, in a single uplink message, using the same transaction ID that corresponds to the received downlink message. As a result, the server may not be informed about other capabilities supported by the device (e.g., through which a successful E911 call may be established) owing to the unavailability of the GNSS chip's response message. Therefore, the call may not proceed and may finally be aborted (e.g., in the first stage of the protocol). Thus, some devices may fail to provide other positioning methods supported by the UE that could be used to determine the location of the UE. This deficiency of some systems can result in E911 calls being dropped. Based on this, some devices may fail to gain access to and reap the benefits of emergency services.

The systems and methods described herein provide a bounded and defined response from the UE's side to the Request Capability message from the network. A configurable timer may be set at the modem (e.g., can be optimized based on hardware and/or software performance of a given device, network, etc.) after sending the capability request to the GNSS chip. The value for the configurable timer may be selected based on the modem consulting with the GNSS. The value for the configurable timer may be set to provide an ample amount of buffer period to allow the GNSS to respond. Accordingly, the Capability response from GNSS may be expected before a timer expires or before timer overflows (e.g., reaches maximum time value, timer resets to zero, timer starts a new cycle). It is noted that reference to the expiration of a timer may refer to expiration of a countdown timer (e.g., timer counting down and the timer reaching zero) or to expiration of an overflow timer (e.g., timer counting up and the timer reaching a maximum time value, resetting to zero, or starting a new cycle).

In cases where a timer overflow occurs, the modem may initiate the capability information fetch instructions for the other positioning methods (e.g., that are readily available to the modem) without waiting indefinitely for the AGNSS Capability info. In some cases, the location data (e.g., from the GNSS and/or from the other positioning methods) may be encapsulated and may be sent to the network. Based on the provided location information, the call may continue (e.g., based on the additional steps provided by the enhanced protocol), and thus, the systems and methods described herein avoid the effect of E911 calls being dropped. Accordingly, the systems and methods increase reliability of E911 calls, enabling the UE to share its location through GNSS and/or through alternative positioning methods (e.g., based on a request from the network in emergency situations).

In some embodiments, the systems and methods described herein may provide enhanced location-based services for the LPP protocol. Also, the systems and methods described herein may provide a time bounded and defined response to Request Capabilities from the UE side to avoid E911 dropped calls. Additionally, the systems and methods described herein may provide or may be based on a UE modem configured to initiate capability information fetch instructions for alternative positioning methods.

In various embodiments, the systems and methods described herein include systems, methods, and apparatuses for increasing reliability in responding to request capability messages in relation to E911 control plane calls. In some aspects, the techniques described herein relate to a method of location management based on capability requests, the method including: providing a request for first position information to an integrated circuit of a user equipment (UE) based on a capability request from a core network or a base station associated with a core network of the UE; determining that the request for the first position information fails based on receipt of the first position information being in a pending state after a period of time has passed; determining, in response to the request for the first position information failing, second position information different from the first position information; and sending a response message, the response message including the second position information.

In some aspects, the techniques described herein relate to a method, further including setting the timer based on sending the request for the first position information to the integrated circuit.

In some aspects, the techniques described herein relate to a method, wherein a modem of the UE configures the timer and initiates the timer, the timer being incorporated in the modem.

In some aspects, the techniques described herein relate to a method, wherein the timer is set to a time value that is based on at least one of a default value, a processing capability of a processor of the UE, or a processing capability of the integrated circuit.

In some aspects, the techniques described herein relate to a method, further including sending the time value to the base station via an acknowledgement (ACK) message that is sent to acknowledge receipt of the capability request.

In some aspects, the techniques described herein relate to a method, wherein the timer is set to a time value that is based on a first time value associated with the request for the first position information and a second time value associated with a request for the second position information.

In some aspects, the techniques described herein relate to a method, wherein: the integrated circuit includes a global navigation satellite system (GNSS) chip of the UE, and the first position information includes satellite-based position information.

In some aspects, the techniques described herein relate to a method, wherein the second position information includes communication-based position information of the UE based on at least one of a time measurement associated with communication of the UE or a signal angle associated with communication of the UE.

In some aspects, the techniques described herein relate to a method, wherein the second position information is based on at least one of enhanced cell ID (ECID), new radio (NR)-ECID, time difference of arrival (TDoA), UL-TDOA, observed time difference of arrival (OTDOA), downlink (DL)-OTDOA, multi-round trip time (multi-RTT), angle of departure (AoD), DL-AOD, angle of arrival, or uplink (UL)-AoA.

In some aspects, the techniques described herein relate to a method, wherein the capability request from the base station is communicated via a non-access stratum (NAS) message and received via a control plane of the UE.

In some aspects, the techniques described herein relate to a device including: one or more processors; and memory storing instructions that, when executed by the one or more processors, cause the device to: send, to an integrated circuit of the device, a request for first position information based on the device receiving a capability request from a core network of the device; determine that the request for the first position information times out based on receipt of the first position information being in a pending state when a timer expires; determine, based on the request for the first position information timing out, second position information different from the first position information; and send a response message to the core network, the response message including the second position information.

In some aspects, the techniques described herein relate to a device, wherein the instructions, when executed by the one or more processors, further cause the device to set the timer based on sending the request for the first position information to the integrated circuit.

In some aspects, the techniques described herein relate to a device, wherein a modem of the device configures the timer and initiates the timer, the timer being incorporated in the modem.

In some aspects, the techniques described herein relate to a device, wherein the timer is set to a time value that is based on at least one of a default value, a processing capability of a processor of the device, or a processing capability of the integrated circuit.

In some aspects, the techniques described herein relate to a device, wherein the instructions, when executed by the one or more processors, further cause the device to send the time value to the core network via an acknowledgement (ACK) message that is sent to acknowledge receipt of the capability request.

In some aspects, the techniques described herein relate to a device, wherein the timer is set to a time value that is based on a first time value associated with the request for the first position information and a second time value associated with a request for the second position information.

In some aspects, the techniques described herein relate to a device, wherein: the integrated circuit includes a global navigation satellite system (GNSS) chip of the device, and the first position information includes satellite-based position information.

In some aspects, the techniques described herein relate to a non-transitory computer-readable medium storing code that includes instructions executable by a processor to: send, to an integrated circuit of a user equipment (UE), a request for first position information based on the UE receiving a capability request from a core network of the UE; determine that the request for the first position information times out based on receipt of the first position information being in a pending state when a timer expires; determine, based on the request for the first position information timing out, second position information different from the first position information; and send a response message to the core network, the response message including the second position information.

In some aspects, the techniques described herein relate to a non-transitory computer-readable medium, wherein the code includes further instructions executable by the processor to set the timer based on sending the request for the first position information to the integrated circuit.

In some aspects, the techniques described herein relate to a non-transitory computer-readable medium, wherein a modem of the UE configures the timer and initiates the timer, the timer being incorporated in the modem.

The systems and methods described herein provide multiple benefits and advantages. For example, the systems and methods provide a bounded response introduced at the UE modem, avoiding E911 dropped calls in cases where the AGNSS Capability response is not received from the GNSS chip to send the Provide Capability message to the network. Also, based on the systems and methods described, the message is built for the other positioning methods requested and is sent to the network (e.g., no message sent to the network previously even if the data for the other positioning methods is readily available to the modem and hence the call dropped) and hence, the call goes through.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example of a system in accordance with example implementations described herein.

FIG. 2 illustrates an example of a system in accordance with example implementations described herein.

FIG. 3 illustrates an example of a system in accordance with example implementations described herein.

FIG. 4 illustrates an example of a system in accordance with example implementations described herein.

FIG. 5 illustrates an example system flow in accordance with one or more implementations as described herein.

FIG. 6 illustrates an example system flow in accordance with one or more implementations as described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

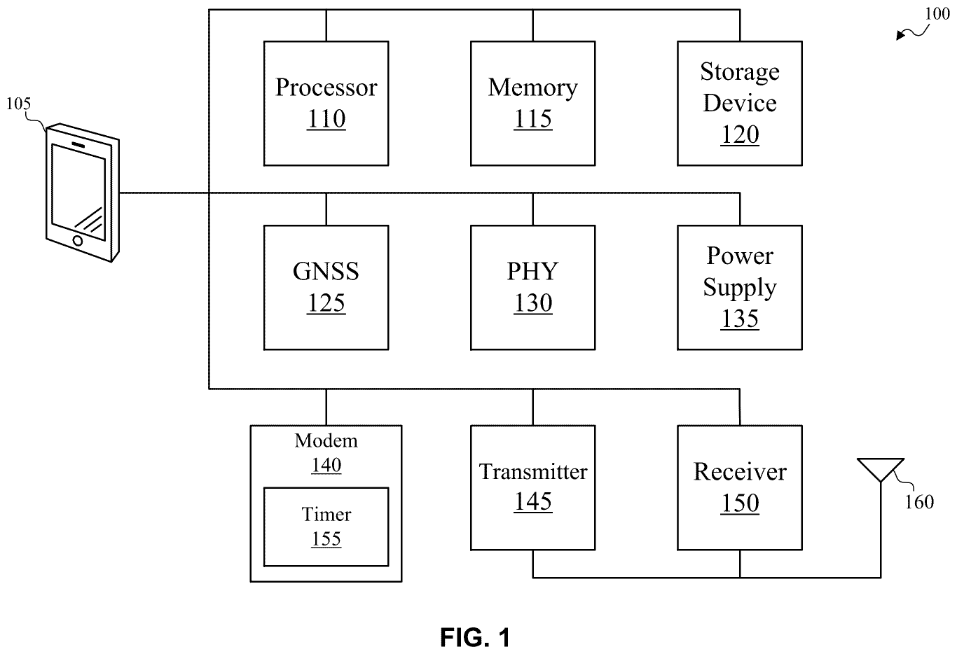

FIG. 1 illustrates an example of a system 100, of a wireless communications network, that supports increasing reliability in responding to request capability messages in relation to E911 control plane calls with example implementations described herein.

As shown, system 100 may include device 105. Device 105 may include a mobile device, a cellphone, a smartphone, a tablet, a laptop, a wearable computing device, an Internet-of-things device, a user equipment (UE), or any wireless/wired network-connected device. Device 105 may communicate with one or more devices via at least one network (e.g., short-range wireless communication network, long-range wireless communication network). The device 105 may include a processor 110, a memory 115, a storage device 120, a global navigation satellite system (GNSS) 125 (e.g., GNSS chipset), a physical layer (PHY) 130, a power supply 135, a modem 140, at least one transceiver (e.g., transmitter 145, receiver 150), and at least one antenna (e.g., antenna 160).

In some cases, device 105 may include an input device, a sound output device, a display device, an audio module, a sensor module, an interface, a haptic module, a camera module, a communication module, a subscriber identification module (SIM) card, or an antenna module. In one embodiment, at least one component (e.g., display device, camera module) may be omitted from device 105, or one or more other components may be added to device 105. Some of the components may be implemented as a single integrated circuit (IC). For example, a sensor module (e.g., a fingerprint sensor, an iris sensor, or an illuminance sensor) may be embedded in a display of device 105.

In some cases, processor 110 may execute software (e.g., a program) to control at least one other component (e.g., a hardware, a software component, etc.) of device 105 coupled with processor 110. Processor 110 may perform various data processing or computations.

As at least part of the data processing or computations, processor 110 may load a command or data received from another component (e.g., modem 140, receiver 150, etc.) in memory 115, process the command or the data stored in memory 115, and store resulting data in storage device 120. In some cases, processor 110 may include a main processor (e.g., a central processing unit (CPU) or an application processor (AP)), and an auxiliary processor (e.g., a graphics processing unit (GPU), an image signal processor (ISP), a sensor hub processor, and/or a communication processor (CP)) that is operable independently from, or in conjunction with, the main processor. Additionally, or alternatively, the auxiliary processor may be adapted to consume less power than the main processor, or execute a particular function. The auxiliary processor may be implemented as being separate from, or a part of, the main processor.

In some examples, memory 115 may store various data used by at least one component (e.g., processor 110, modem 140, etc.) of device 105. The various data may include, for example, software (e.g., a program, application) and input data or output data for a command related thereto. In some cases, memory 115 may include volatile memory (e.g., random-access memory (RAM) dynamic RAM (DRAM), static RAM (SRAM)) and/or non-volatile memory (e.g., NAND flash memory). In some cases, memory 115 and/or storage device 120 may include internal memory and/or external memory. One or more programs may be stored in the memory 115 as software, and may include, for example, an operating system (OS), middleware, and/or an application.

In some examples, GNSS 125 may enable satellite navigation on device 105. GNSS 125 may include a GNSS chipset (e.g., an integrated circuit (IC) or set of chips) that forms the core of a GNSS receiver. For example, GNSS 125 may enable device 105 to be a GNSS receiver, enabling device 105 to determine its location, time, and velocity using signals from GNSS satellites, which may include at least one of a global positioning system (GPS) satellite, a Galileo satellite, a global navigation satellite system (GLONASS) satellite, etc. GNSS 125 may be configured to receive and process GNSS signals. In some cases, GNSS 125 may be configured to receive messages from modem 140. For example, modem 140 may send a GNSS request to GNSS 125 requesting GNSS information. In some cases, GNSS 125 may receive satellite ephemeris data from a satellite and determine at least one of longitude, latitude, time, and/or velocity of device 105 based on the satellite ephemeris data.

PHY 130 may include an electronic circuit configured to implement physical layer functions of the open systems interconnection (OSI) model in a network interface controller. PHY 130 may connect a link layer device (e.g., medium access control (MAC) to a physical medium of device 105 (e.g., radio waves, electromagnetic radiation, radiofrequency (RF) energy).

In some examples, power supply 135 (e.g., a battery, a power adapter, power management module, etc.) may supply power to at least one component of device 105. In some examples, power supply 135 may include, for example, a cell (e.g., primary cell) that is not rechargeable, a cell (e.g., secondary cell) that is rechargeable, a fuel cell, etc.

In some examples, modem 140 may enable device 105 to connect to a network (e.g., LTE network, 5G network). In conjunction with transmitter 145 and receiver 150, modem 140 may be configured to manage radio communication, receiving and transmitting signals between a base station and device 105. In some cases, modem 140 may manage encoding and decoding of data, allowing device 105 to send and receive information (e.g., browsing the internet, making calls, or streaming video). Modem 140 may be configured to control one or more aspects of a user plane, managing data transmission between device 105 and the applications or servers accessed by device 105.

As shown, modem 140 may include at least one timer (e.g., timer 155). Timer 155 may be configured to time one or more operations, indicate or measure a time period, indicate a lapse of time, indicate an expiration, indicate a timeout, etc. In some cases, timer 155 may be configured to indicate a lapse of time, indicate an expiration, and/or indicate a timeout in relation to modem 140 and one or more components of device 105. For example, timer 155 may be configured to indicate a lapse of time, indicate an expiration, and/or indicate a timeout in relation to modem 140 and GNSS 125. In some instances, modem 140 may send a request to GNSS 125. For example, modem 140 may request that GNSS 125 provide capability information of device 105 (e.g., location, time, and/or velocity of device 105) based on device 105 receiving a request from a network (e.g., core network, base station). When modem 140 sends the capability information request to GNSS 125, modem 140 may initiate a timer via timer 155. For example, modem 140 may set the time based on some time period (e.g., any value between 100 ms and 5000 ms). In some cases, the time period may be based on a default time period or a custom time period based on a capability of device 105 (e.g., processing capability such as processor speed, a GNSS capability such as GNSS chip speed, etc.). When GNSS 125 provides the capability information before a lapse of the time period, modem 140 may provide the capability information to the requesting network. When modem 140 determines, via timer 155, that the timer is expired and GNSS 125 has not provided the capability information, modem 140 may perform one or more alternative operations (e.g., provide alternative capability information to the requesting network). Based on the systems and methods described herein, system 100 may increase the reliability of responding to request capability messages in relation to data communications of device 105 (e.g., reliability of e911 control plane calls). In some examples, a protocol may specify a response time for location information exchange. In some cases, modem 140 may configure timer 155 based on corresponding information included in a downlink message.

A communication module of device 105 may support establishing a direct (e.g., wired) communication channel and/or a wireless communication channel between device 105 and at least one external electronic device and performing communication via the established communication channel. The communication module may include one or more communication processors that are operable independently from processor 110 and may support a direct (e.g., wired) communication and/or a wireless communication. The communication module may include a wireless communication module (e.g., a cellular communication module, a short-range wireless communication module, a global navigation satellite system communication module such as GNSS 125, etc.) or a wired communication module (e.g., a local area network (LAN) communication module, a power line communication (PLC) module, etc.). A corresponding one of these communication modules may communicate with the external electronic device via at least a first network (e.g., a short-range communication network, such as BLUETOOTH^{TM}, wireless-fidelity (Wi-Fi) direct, a standard of the Infrared Data Association (IrDA)) or a second network (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module may identify and/or may authenticate device 105 in a communication network using subscriber information (e.g., international mobile subscriber identity (IMSI)) stored in the subscriber identification module.

In some examples, antenna 160 (e.g., of transmitter 145 and/or receiver 150) may transmit a signal (e.g., RF energy) to and/or receive a signal from or one or more devices external to device 105. Antenna 160 may include one or more antennas, and, therefrom, at least one antenna appropriate for a communication scheme used in the communication network. The signal or the power may then be transmitted or received transmitter 145 and/or receiver 150 of device 105 and an external electronic device via a selected at least one antenna (e.g., antenna 160).

Commands or data may be transmitted or received between device 105 and an external electronic device via a server coupled to at least one network. All or some of operations executed at device 105 may be executed at one or more external electronic devices. For example, if device 105 performs a function or a service automatically, or in response to a request from a user or another device, device 105, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to device 105. The device 105 may provide the outcome, with or without further processing of the outcome, as at least part of a reply to the request. To that end, a cloud computing, distributed computing, or client-server computing technology may be used, for example.

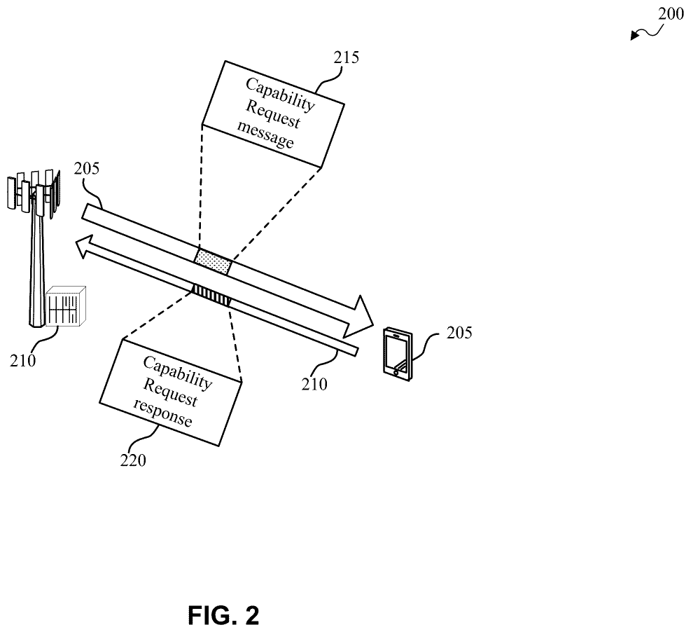

FIG. 2 illustrates an example of a system 200, of a wireless communications network, that supports increasing reliability in responding to request capability messages in relation to E911 control plane calls with example implementations described herein.

As illustrated, wireless communications system 200 may include device 205 and base station 210. Base station 210 may connect device 205 to a core network (e.g., a central, high-speed backbone of a telecommunications network, responsible for routing data and connecting different parts of the network). Device 205 may be an example of device 105, as described above with reference to FIG. 1. Wireless communications system 200 may also include downlink 215 and uplink 220. Base station 210 may use downlink 215 to convey control and/or data information to device 205. And device 205 may use uplink 220 to convey control and/or data information to base station 210. In some cases, downlink 215 may use different time and/or frequency resources than uplink 220. In some cases, base station 210 may be associated with a geographic coverage area in which communications with one or more UEs (e.g., device 205) is supported.

Device 205 may receive one or more transmissions from base station 210. In some cases, the one or more transmissions may include a configuration or an indication of a configuration for device 205 (e.g., to enable a timer, such as timer 155, in relation to requests for location information, such as capability request messages). In some cases, device 205 may receive the configuration in a radio resource control message or a media access control (MAC) control element (MAC-CE) message, or both.

In some examples, the one or more transmissions may include a capability request message. In some cases, the capability request message may include a UE capability enquiry message configured to enable base station 210 to discover the supported features and functionalities of device 205 for optimal network resource allocation and communication. When a network updates its knowledge of the capabilities of a UE (e.g., device 105), the MME of a core network may initiate a capability request message (e.g., the capability request message of downlink 215). In some examples, the MME may trigger base station 210 to send the capability request message to device 105 (e.g., via the radio resource control (RRC) layer).

Upon receiving the capability request message, device 105 may respond with a capability request response (e.g., the capability request response of uplink 220) containing supported features, functionalities, etc., of device 105. As shown, the capability request response may be sent back to base station 210, and base station 210 may relay this information to the MME. The network may use the capability information of device 105 to tailor its communication with device 105, ensuring optimal performance and resource utilization. For example, the network can choose the appropriate frequency bands, modulation schemes, and other parameters based on the capabilities of device 105.

Accordingly, a network may send a UE Capability Enquiry message (e.g., the capability request message of downlink 215) to gather information about a UE's capabilities (e.g., capabilities of device 205), enabling the network to optimize its communication with the UE and ensure efficient resource allocation. The network may request the UE's capabilities, including location-related ones, to properly configure the UE and provide the appropriate services, including location-based services.

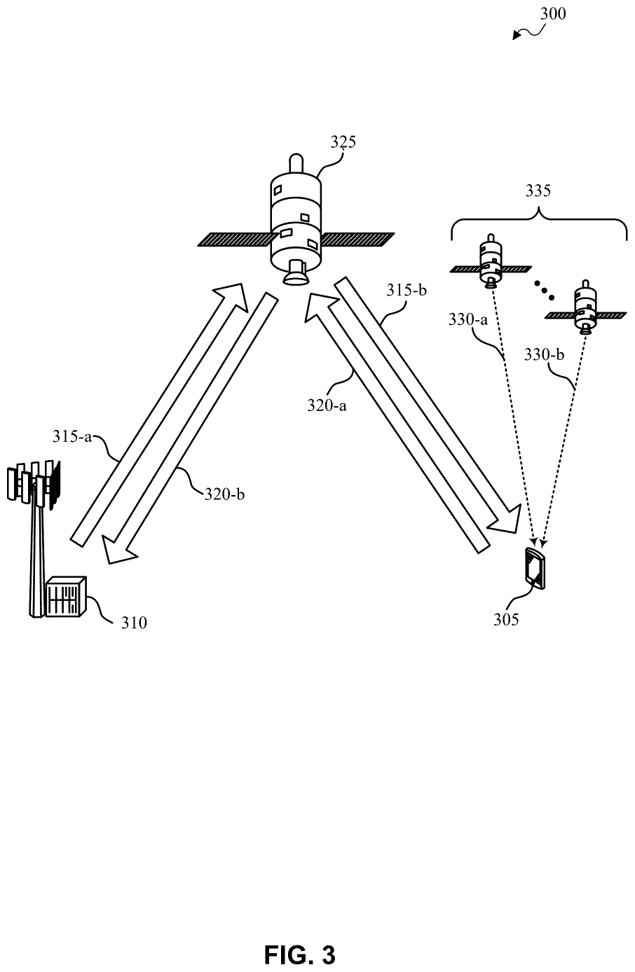

FIG. 3 illustrates an example of a system 300, of a wireless communications network, that supports increasing reliability in responding to request capability messages in relation to E911 control plane calls with example implementations described herein.

In some examples, wireless communications system 300 may implement aspects of system 100 and/or system 200. Wireless communications system 300 may include a device 305, base station 310, a satellite 325, and a satellite system 335. Device 305 may be an example of device 105 of FIG. 1 and/or device 205 of FIG. 2. Base station 310 may be an example of base station 210 of FIG. 2.

The wireless communications system 300 may support transmissions between device 305 and satellite 325. For example, device 305 may transmit an uplink transmission 320 to satellite 325. In some examples, satellite 325 may transmit a downlink transmission 315 to device 305. Satellite 325 may be in an orbit, such as low earth orbit, medium earth orbit, geostationary earth orbit, or other non-geostationary earth orbit. In any of these examples, satellite 325 may be some distance from Earth (e.g., hundreds or thousands of kilometers from Earth), and therefore may be at least the same distance from device 305. Each communication (e.g., downlink transmission 315, uplink transmission 320) between satellite 325 device 305 may therefore travel from Earth the distance to satellite 325 and back to Earth.

In some examples, device 305 may include an antenna configured to receive positioning signals 330 (e.g., positioning signal 330-a, positioning signal 330-b) transmitted by one or more satellites of satellite system 335. For example, device 305 may be configured to receive positioning signals 330 from a global navigation satellite system (GNSS) (e.g., GPS, GLONASS, Galileo, etc.). Additionally, or alternatively, device 305 may be configured to receive positioning signals 330 from another system, such as an airplane positioning system, a drone positioning system, an unmanned aerial vehicle positioning system, a balloon positioning system, a dirigible positioning system, a land-based positioning system (e.g., triangulation of signals from base stations, wireless access points, etc.), a local positioning system, or a combination thereof transmitting signals that may be used to determine the position of a receiving device (e.g., device 305).

In some examples, satellite 325 may provide ephemeris information to device 305. In some cases, satellite 325 may provide ephemeris information to device 305 via downlink transmission 315-b. Satellite 325 may be referred to as a serving satellite or as a base station. In some cases, satellite system 335 may include one or more satellites (e.g., a network of positioning satellites). In some cases, device 305 may acquire a global navigation satellite system fix via the one or more satellites of satellite system 335. In some cases, device 305 may acquire a global navigation satellite system fix via positioning signals 330.

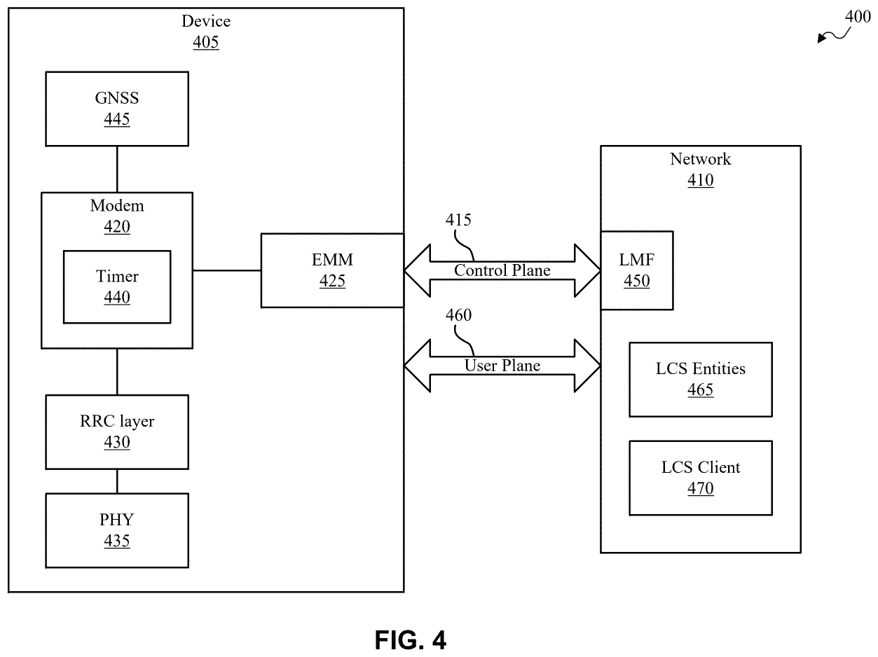

FIG. 4 illustrates an example system 400, of a wireless communications network, that supports increasing reliability in responding to request capability messages in relation to E911 control plane calls with example implementations described herein. In some configurations, one or more aspects of system 400 may be implemented by or in conjunction with device 105 of FIG. 1, device 205 of FIG. 2, and/or base station 210 of FIG. 2. In some configurations, one or more aspects of system 400 may be implemented by or in conjunction with device 105, components of device 105, device 205, components of device 205, base station 210, component of base station 210, device 305, components of device 305, base station 310, component of base station 310, or any combination thereof.

In the illustrated example, system 400 may include device 405, network 410, control plane 415, and user plane 460. Device 405 may be an example of device 105 of FIG. 1, device 205 of FIG. 2, and/or device 305 of FIG. 3. In some cases, device 405 may connect to network 410 via a core network (e.g., network 410). Device 405 may include modem 420, evolved packet system (EPS) mobility management (EMM) 425, radio resource control (RRC) layer 430, physical layer (PHY) 435, and GNSS 445.

Modem 420 may facilitate a connection between device 405 and network 410, enabling communication and data transfer. Modem 420 may translate digital data from device 405 into radio signals that are transmitted/received over network 410. Modem 420 may manage the transmission and reception of data, enabling device 405 to browse the Internet, stream videos, make calls, access other services through network 410. Modem 420 may be configured to handle mobility management (e.g., via EMM 425), managing connections as device 405 moves between different cell towers, handling voice calls and other real-time communication services, etc. In some cases, modem 420 may authenticate device 405 with network 410. As shown, modem 420 may include timer 440. Timer 440 may be an example of timer 155 of FIG. 1.

EMM 425 may be configured (e.g., in conjunction with modem 420) to manage mobility and registration within a given network of device 405. EMM 425 may enable device 405 to connect to network 410, roam between different cells and networks, maintain a secure connection for accessing services, etc.

RRC layer 430 may manage a radio connection between device 405 and network 410 (e.g., via base station 210, base station 310). RRC layer 430 may set up, maintain, and/or release radio connections, ensuring seamless communication between device 405 and network 410.

PHY 435 may be an example of PHY 130. PHY 435 can include flexible multi-carrier waveforms, advanced multi-antenna solutions, and channel coding schemes for a wide range of services, deployments, and frequencies. In some cases, PHY 435 may enable at least one of a Non-Access Stratum (NAS) protocol, a Radio Resource Control (RRC) protocol (e.g., RRC messages in conjunction with RRC layer 430), a Packet Data Convergence Protocol (PDCP) protocol (e.g., PDCP data transfer), Radio Link Control (RLC) protocol (e.g., transfer of packet data units), and/or Medium Access Control (MAC) protocol (e.g., receive user plane data and/or control plane data).

In some examples, GNSS 445 (e.g., GNSS chip, GNSS chipset) may receive signals from a GNSS satellite (e.g., GPS satellite, GLONASS satellite, Galileo satellite, etc.), which may broadcast signals containing information about the location and time of the satellite. GNSS 445 may use these signals to determine a location of device 405 using location determination techniques, such as trilateration (e.g., measuring distances to multiple satellites). GNSS signals received by GNSS 445 may be used to determine precise timing information, enabling device 405 to synchronize with network 410 and ensure reliable communication. By combining GNSS data with cellular positioning, GNSS 445 and modem 420 may increase the accuracy and reliability of positioning information. Accordingly, GNSS 445 may be configured as a location and timing engine of device 405, enabling precise and reliable positioning and timing capabilities for applications and services of network 410.

System 400 and methods associated with system 400 may be based on and/or may be implemented in conjunction with control plane 415. Control plane 415 can include a part of a network that handles signaling and control information for establishing, maintaining, and managing communication sessions between device 405 and a core network (e.g., network 410). Control plane 415 may be used for tasks such as connection setup, mobility management (handoffs), resource allocation, location management, etc.

System 400 and methods associated with system 400 may be based on and/or may be implemented in conjunction with user plane 460 (e.g., data plane). User plane 460 can include part of a network that handles transmission of user data, or the pathway for the information being sent and/or received by device 405 (e.g., voice calls, web browsing, video streaming, file downloads, etc.). Accordingly, while user plane 460 may carry the data flow (e.g., voice calls, video streams), control plane 415 may manage the instructions and signals that enable the data flows.

In some cases, network 410 may include a core network. As shown, network 410 may include location management function (LMF) 450, location services (LCS) entities 465, and LCS client 470. System 400 and methods associated with system 400 may be based on and/or may be implemented in conjunction with LMF 450. LMF 450 (e.g., of a core network, of a base station) can include network functions configured to determine the geographic location of device 405 and provide this location information to authorized entities.

In some examples, modem 420 may receive a location request (e.g., based on or part of a capability request) from a core network of device 405 (e.g., network 410, base station 210, base station 310, etc.). In some cases, the location request from the core network may be communicated via a non-access stratum (NAS) message and received by device 405 via control plane 415. In some cases, upon reception of the location request (e.g., based on a request capability message from network 410 including the location request), modem 420 may determine if capability data pertaining to GNSS is requested in the location request.

In some cases, the location request may originate with LCS client 470 and at least one LCS entity (e.g., LCS entities 465) may relay the request to a base station, and the base station may relay the request to device 405. LCS entities such as LCS entities 465 may include one or more entities configured to manage a location services architecture of network 410, which may enable location information for mobile devices, such as device 405. LCS client 470 may include an application or an external entity (e.g., an entity remote to device 405 and/or remote to a base station connected to device 405) that requests location information for a mobile device (e.g., device 405). In some examples, LCS entities 465 may include at least one location server configured to interact with a network infrastructure (e.g., network 410) to request the location information of a target UE (e.g., device 405). In some cases, LMF 450 and/or LCS client 470 may be connected to or incorporated in LCS entities 465. In some cases, an LCS architecture of LCS entities 465 may use a client/server model, where a positioning node acts as the server. Location services enabled by LCS entities 465 may be used in multiple public operations, including emergency services, vehicle tracking, advertising, etc.

When modem 420 determines that capability data pertaining to GNSS is requested in the location request, modem 420 may pass on this request to GNSS 445, requesting AGNSS capability info. For example, modem 420 may send, to GNSS 445, a request for first position information (e.g., satellite-based position information) based on the location request from the core network. Modem 420 may configure timer 440 (e.g., program timer 440 with a time value) based on sending the request for the first position information to GNSS 445.

In some cases, modem 420 may set timer 440 to a time value that is based on at least one of a default value, a processing capability of at least one component of device 405 (e.g., processing capability of a processor of device 405, processing capability of GNSS 445, processing capability of PHY 435, etc.). In some examples, a time value for timer 440 may be chosen independent of network 410 for one or more positioning methods requested by network 410. In some cases, the timer value may be determined based on a cumulative sum of individual time values for respective position information requested by network 410. For example, a first time value may be selected for first position information requested by network 410 (e.g., satellite-based position information), a second time value may be selected for second position information requested by network 410 (e.g., communication-based position information), and so on. Accordingly, a countdown timer value for timer 440 may be based on at least the first time value and the second time value (e.g., a sum of the first time value and the second time value). In some cases, modem 420 may send the time value of timer 440 to network 410 (e.g., to a base station of network 410 that is communicatively linked to device 405). In some cases, modem 420 may send the time value of timer 440 via a RRC message based on RRC layer 430.

In some examples, modem 420 may activate timer 440 (e.g., initiate a countdown, measure an amount of time that elapses upon activation of timer 440). Modem 420 may monitor timer 440 to determine whether the countdown expires or whether the measured amount of time that elapses reaches a set time value. It is noted that reference to the expiration of a timer may refer to expiration of a countdown timer (e.g., timer counting down and the timer reaching zero) or to expiration of an overflow timer (e.g., timer counting up and the timer reaching a maximum time value, resetting to zero, or starting a new cycle).

In some examples, modem 420 may determine that the request for the first position information times out based on receipt of the first position information being in a pending state when the countdown expires or when the measured lapsed amount of time reaches the set time value. Based on the request for the first position information timing out, modem 420 may determine a second position information (e.g., communication-based position information) different from the first position information.

In some examples, modem 420, in conjunction with PHY 435, may determine the second position information. In some cases, the second position information may include communication-based position information that device 405 determines via PHY 435. In some examples, the second position information may be based on at least one of a time measurement associated with communication of device 405 and/or a signal angle associated with communication of device 405. For example, the second position information may be based on at least one of enhanced cell ID (ECID), new radio (NR)-ECID, time difference of arrival (TDoA), UL-TDOA, observed time difference of arrival (OTDOA), downlink (DL)-OTDOA, multi-round trip time (multi-RTT), angle of departure (AoD), DL-AOD, angle of arrival, or uplink (UL)-AoA.

In some examples, in response to capability request from the core network associated with the base station of device 405 (e.g., network 410, base station 210, base station 310, etc.), device 405 may send a response message to the core network. The response message may be based on the request for the first position information timing out and modem 420 determining the second position information. For example, modem 420 may encapsulate the second position information in one or more packets (e.g., with the capability information of any other requested positioning methods) and communicate the one or more packets to network 410 (e.g., to the base station of network 410). In some cases, modem 420 may map the requested information to a support list and send the response to network 410. For example, device 405 may respond with a message that includes its supported radio capabilities, which can include various features like supported frequency bands, modulation schemes, multiple-input multiple-output (MIMO) configurations, other radio-related parameters, etc.

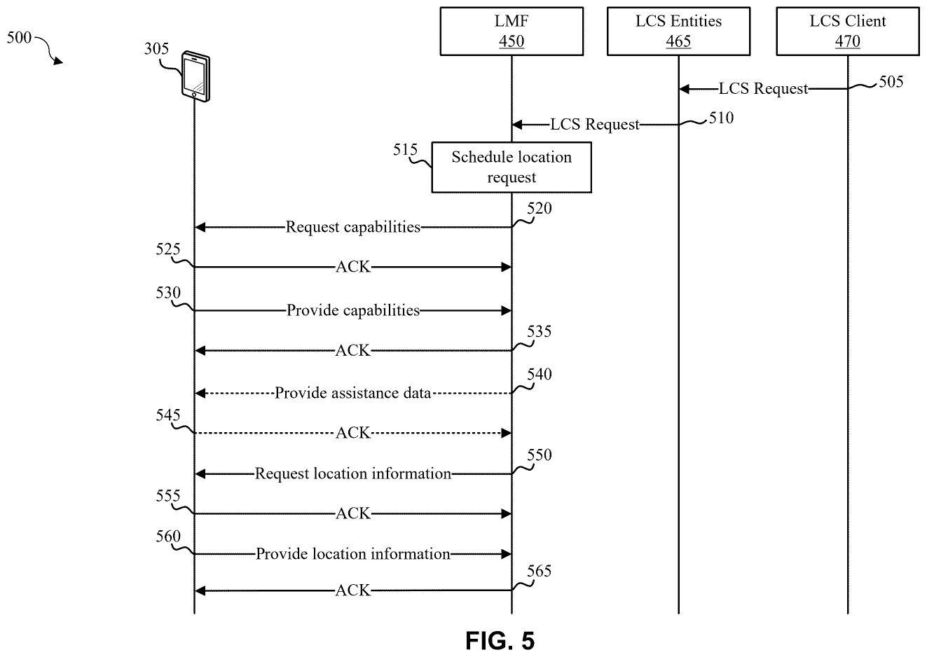

FIG. 5 illustrates an example system flow 500 in accordance with one or more implementations as described herein. In some configurations, one or more aspects of system flow 500 may be implemented by or in conjunction with device 105 of FIG. 1, device 205 or base station 210 of FIG. 2, device 305 or base station 310 of FIG. 3, and/or device 405 or network 410 of FIG. 4.

In the illustrated example, system flow 500 may depict operations associated with a core network. As shown, system flow 500 may depict operations associated with device 305, base station 310, location management function (LMF) 450, at least one location services (LCS) entity (e.g., LCS entities 465), and LCS client 470. One or more messages depicted in system flow 500 may be sent/received based on one or more communication protocols. For example, at least one message depicted in system flow 500 may be based on the non-access stratum (NAS) protocol (e.g., using NAS transport layer). In some cases, a message transmitted from LMF 450 to device 305 (e.g., and from base station 310 to device 305) may include a downlink message (e.g., based on downlink NAS transport), and a message transmitted from device 305 to LMF 450 (e.g., and from device 305 to base station 310) may include an uplink message (e.g., based on uplink NAS transport).

At 505, LCS client 470 send an LCS request to LCS entities 465. LCS client 470 may generate an LCS request and send the LCS request to LCS entities 465. As shown, an LCS client may not communicate directly with a UE (e.g., device 305). However, an LCS client, such as LCS client 470, may request the location of a UE to fulfill some need of the LCS client. Organizations, such as emergency services, law enforcement, or even location-based service providers, may have a need to determine the location of a UE (e.g., emergency services for an E911 call). A given network (e.g., network 410) may be responsible for tracking and managing the location of UEs, such as device 305. An LCS client, such as LCS client 470, may interact with the network infrastructure (e.g., a location server, LMF 450, LCS entities 465) to request the location information of a target UE, such as device 405. The network may use various techniques (e.g., cell tower triangulation, GNSS satellite-based location services, etc.) to determine the location of the target UE and send this information back to the LCS client.

At 510, LCS entities 465 may send or relay the LCS request to LMF 450. For example, based on LCS entities 465 receiving the LCS request from LCS client 470, LCS entities 465 may send or relay the LCS request to LMF 450.

At 515, LMF 450 may schedule a location request. For example, LMF 450 may schedule a location request based on LMF 450 receiving the LCS request from LCS entities 465.

At 520, a core network may send a capability request to device 305. For example, based on the location request scheduled at 515, LMF 450 may send a capability request to device 305. In some cases, communication between device 305 and LMF 450 may be relayed via a base station (e.g., base station 310).

At 525, device 305 may send an acknowledgement (ACK) to a core network (e.g., network 410 via LMF 450). For example, based on device 305 receiving the capability request from LMF 450, device 305 may send an ACK to LMF 450.

At 530, device 305 may send a capability response to the core network. For example, based on device 305 receiving the capability request from base station 310, device 305 may send a capability response to LMF 450.

At 535, the core network may send an ACK to device 305. For example, based on LMF 450 receiving the capability response from device 305, LMF 450 may send an ACK to device 305.

At 540, the core network may send (e.g., optionally send) assistance data to device 305. For example, LMF 450 may provide assistance data to device 305.

At 545, device 305 may send an ACK to the core network. For example, based on device 305 receiving (e.g., optionally receiving) the assistance data from LMF 450, device 305 may send an ACK to LMF 450.

At 550, the core network may send a location information request to device 305. For example, based on the location request scheduled at 515, LMF 450 may send a location information request to device 305.

At 555, device 305 may send an ACK to the core network. For example, based on device 305 receiving the location information request from LMF 450, device 305 may send an ACK to LMF 450.

At 560, device 305 may send a location information response to the core network. For example, based on device 305 receiving the location information request from LMF 450, device 305 may send a location information response to LMF 450.

At 565, the core network may send an ACK to device 305. For example, based on LMF 450 receiving the location information response from device 305, LMF 450 may send an ACK to device 305. In some cases, LMF 450 may relay one or more messages from device 305 (e.g., capability response message, location information response message, etc.) to LCS entities 465, which may relay the one or more messages to LCS client 470.

In some cases, one or more aspects of system flow 500 may be based on the long-term evolution (LTE) Positioning (LPP) protocol, which can include a protocol used to exchange location information across LTE networks, which may be implemented in 5G networks, 6G networks, etc. The LPP Protocol can define a sequence of messages that are exchanged between a UE (e.g., device 305) and a network (e.g., network 410) to acquire location information of the UE, such as messages that may be used during a control plane call. System flow 500 may depict such messages. In some cases, one or more of the messages depicted in system flow 500 may be exchanged through secure user plane location (SUPL) messages in a user plane call (e.g., user place 460).

In some cases, the message initiating the location acquisition procedure may be a Request Capabilities message. A given UE may be capable of acquiring different measurements in order to calculate the location information. Different positioning methods may utilize different sets of measurements.

A Provide Capabilities message may inform the server of different UE positioning capabilities (e.g., whether GPS positioning is present, different modem-side measurements that can be performed, such as ECID, OTDOA, etc.). A location server (e.g., LMF 450, LCS entities 465) that uses the location information may indicate which positioning methods to use for a given call (e.g., for a given E911 call). The location server may indicate the positioning methods to use based on location accuracy constraints, based on positioning method response times, based on the accuracy of a given positioning method, etc.

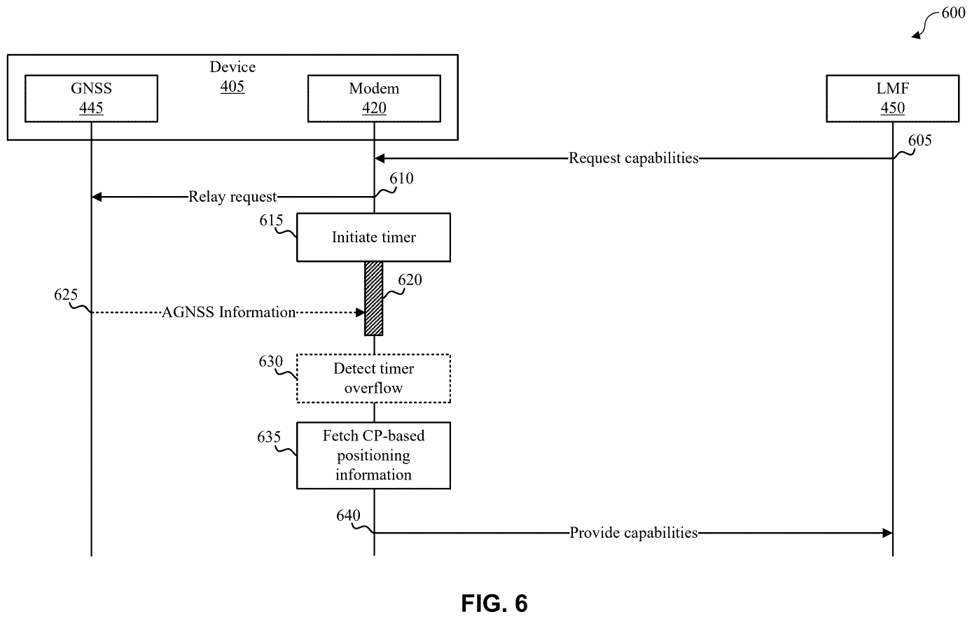

FIG. 6 illustrates an example system flow 600 in accordance with one or more implementations as described herein. In some configurations, one or more aspects of system flow 600 may be implemented by or in conjunction with device 105 of FIG. 1, device 205 or base station 210 of FIG. 2, device 305 or base station 310 of FIG. 3, and/or device 405 or network 410 of FIG. 4.

In the illustrated example, system flow 600 may depict operations associated with a core network. As shown, system flow 600 may depict operations associated with device 405, GNSS 445 of device 405, modem 420 of device 405, and LMF 450. One or more messages depicted in system flow 600 may be sent/received based on one or more communication protocols. For example, at least one message depicted in system flow 600 may be based on the non-access stratum (NAS) protocol (e.g., using NAS transport layer). In some cases, a message transmitted from LMF 450 to device 305 (e.g., and from a base station relayed to device 305) may include a downlink message (e.g., based on downlink NAS transport), and a message transmitted from device 305 to LMF 450 (e.g., and from device 305 to base station 310) may include an uplink message (e.g., based on uplink NAS transport).

At 605, LMF 450 may send a capability request to device 405. As shown, the capability request may be communicated to device 405 via a control plane (e.g., control plane 415), and may be received by modem 420 of device 405.

At 610, the capability request may be relayed via modem 420. For example, device 405, via modem 420, may relay the capability request to GNSS 445.

At 615, modem 420 may initiate a timer. For example, modem 420 may program a timer (e.g., timer 155, timer 440) with a time, and modem 420 may activate the timer, causing the timer to start counting down from the set time. Alternatively, modem 420 may activate the timer (e.g., initialize timer to zero or some offset time value), and the timer may start to count up.

At 620, modem 420 may monitor the timer to determine when the countdown expires (e.g., reaches zero or some set time value based on the timer counting down), or modem 420 may monitor the timer to determine when the timer reaches some set time (e.g., reaches some set time value based on the timer counting up).

At 625, GNSS 445 may send satellite information (e.g., AGNSS information) to modem 420. In some cases, GNSS 445 may provide the requested satellite information before a countdown on the timer expires, or before the timer reaches some time based on the timer counting up.

At 630, modem 420 may detect a timer overflow condition. For example, modem 420 may determine that a countdown on the timer expires, or may determine the timer reaches some time based on the timer counting up (e.g., overflows, resets to zero, starts a new cycle).

At 635, modem 420 may determine additional or alternative positioning information (e.g., communication processor/modem-based positioning information, communication-based positioning information). For example, modem 420 (e.g., in conjunction with a PHY, such as PHY 435) may determine the additional/alternative positioning information based on at least one of a time measurement associated with communication of device 405 and/or a signal angle associated with communication of device 405. For example, the additional/alternative position information may be based on at least one of enhanced cell ID (ECID), new radio (NR)-ECID, time difference of arrival (TDoA), UL-TDOA, observed time difference of arrival (OTDOA), downlink (DL)-OTDOA, multi-round trip time (multi-RTT), angle of departure (AoD), DL-AOD, angle of arrival, uplink (UL)-AoA, etc.

At 640, modem 420 may send a capability response message to LMF 450. For example, based on GNSS 445 sending satellite information to modem 420 before a countdown on the timer expires or before the timer reaches some time based on the timer counting up, modem 420 may include the satellite information in the capability response message modem 420 sends to LMF 450. Additionally, or alternatively, based on modem 420 determining the additional/alternative positioning information, modem 420 may include the additional/alternative positioning information in the capability response message modem 420 sends to LMF 450.

In some cases, this timed wait at 620 may be extended to a second position or another position information fetch based on applicability or system configuration. For example, the wait time may be extended up until the additional or alternative positioning information is fetched at 635 and/or before sending the capability response message at 640. In some cases, modem 420 may receive the satellite message relatively near the time modem 420 receives the additional/alternative positioning information. In such a case, modem 420 may include the satellite information with the additional/alternative positioning information in the capability response message.

Based on the systems and methods described herein, when a response time is not incorporated in a downlink message (e.g., capability information request), modem 420 still ensures a bounded and definite response to the downlink request message by introducing a windowed approach on the modem's end without modification to an applicable protocol (e.g., LPP) protocol, no overhead on the other entities involved in the positioning procedure). Thus, the systems and method described help sustain a call and avoid unnecessary E911 call drop cases.

In some cases, a call may get dropped since an applicable protocol (e.g., LPP protocol) may not specify a response time for the capability request, but may expect a response within a particular timeframe. A call may get dropped when there is no response from the UE. The core network may send out the capability request multiple times (e.g., 3 times). For example, the core network may repeat the capability request when there is no response received, before finally dropping the connection after a number of attempts. However, the systems and methods described herein fill in this service gap by introducing the windowed approach on the modem's side, thereby sustaining the call.

It is noted that the systems and methods described herein may be applied to a reverse mode of LPP extensions (LPPe). LPPe reverse mode can refers to a capability of a mobile device to initiate a request for location information from a network server, where the device pushes its own location data to the server (e.g., LMF 450) instead of the server first requesting location data from the device. LPPe reverse mode can allow the device to proactively share its position, rather than passively waiting for a request. Thus, additionally, or alternatively, device 405 (e.g., via modem 420) may request satellite information based on an expiration, fetch the CP-based positioning information, and send a capability message (e.g., including the CP-based positioning information and/or the satellite information) to LMF 450, where this capability message is independent of or separate from the request at 605.

It is also noted that the method the systems and methods described herein may be

applied to a user plane call. For example, the systems and methods described herein may be implemented based on secure user plane location (SUPL). SUPL can include an IP-based protocol that uses the user plane to provide location services to mobile devices. SUPL may be implemented with Assisted GPS (A-GPS). In some cases, a GNSS chipset (e.g., GNSS 445) may be configured to interact with a core network element (e.g., network 410, LMF 450) where the windowing may be applied at the GNSS chipset for the capabilities that are provided by a communication processor (CP) (e.g., of a communication module of device 105, processor 110, etc.). In some cases, SUPL may be used for satellite information based on a GNSS chipset and/or additional capability information requested from a modem chipset (e.g., modem 420). Accordingly, one or more aspects of the systems and methods described herein may be based on an SUPL implementation that includes requesting satellite information from a GNSS chipset based on a timer and/or requesting CP-based positioning information, and then sending a capability message to a core network (e.g., LMF 450), where the capability message includes the CP-based positioning information and/or the satellite information.

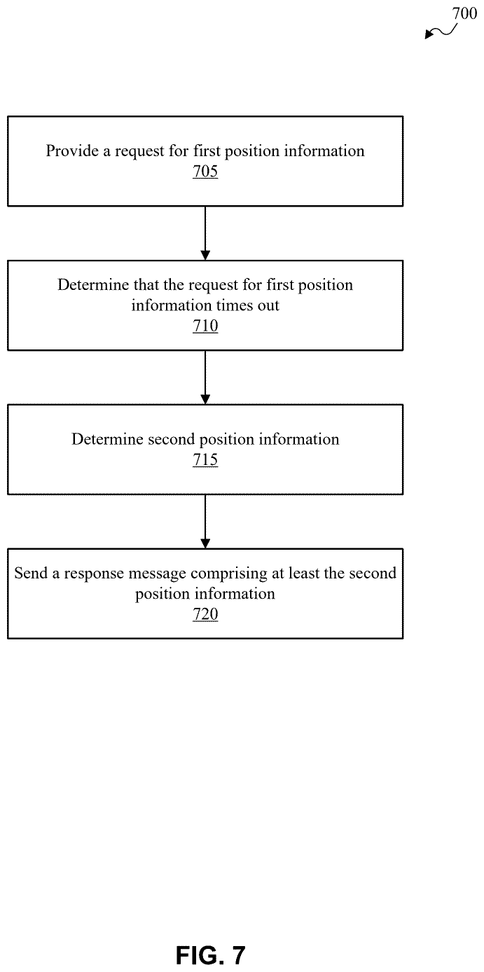

FIG. 7 depicts a flow diagram illustrating an example method 700 associated with the disclosed systems, in accordance with example implementations described herein. In some configurations, one or more aspects of method 700 may be implemented by or in conjunction with modem 140 of FIG. 1 and/or modem 420 of FIG. 4. In some configurations, one or more aspects of method 700 may be implemented by or in conjunction with device 105 of FIG. 1, device 205 or base station 210 of FIG. 2, device 305 or base station 310 of FIG. 3, device 405 or network 410 of FIG. 4, or any combination thereof. The depicted method 700 is just one implementation and one or more operations of method 700 may be rearranged, reordered, omitted, and/or otherwise modified such that other implementations are possible and contemplated.

At 705, method 700 may include providing a request for first position information. For example, a modem (e.g., modem 420) may provide, to an integrated circuit of a UE (e.g., GNSS 445 of device 405), a request for first position information (e.g., AGNSS information) based on the UE receiving a location request from a core network or a base station (e.g., base station 310) associated with a core network of the UE (e.g., network 410).

At 710, method 700 may include determining that the request for first position information times out. For example, the modem may determine that the request for the first position information times out (e.g., expires, overflows) based on receipt of the first position information being in a pending state when a timer expires (e.g., the modem does not receive the first position information before the timer expires or before the timer overflows).

At 715, method 700 may include determining second position information. For example, the modem may determine second position information (e.g., communication-based position information). The second position information may be different from the first position information. In some cases, the modem may determine the second position information based on a location request that requests the first position information and/or the second position information. In some cases, the modem may determine the second position information based on the request for the first position information timing out.

At 720, method 700 may include sending a response message comprising at least the second position information. For example, the modem may send a response message to the base station, where the response message may include the second position information.

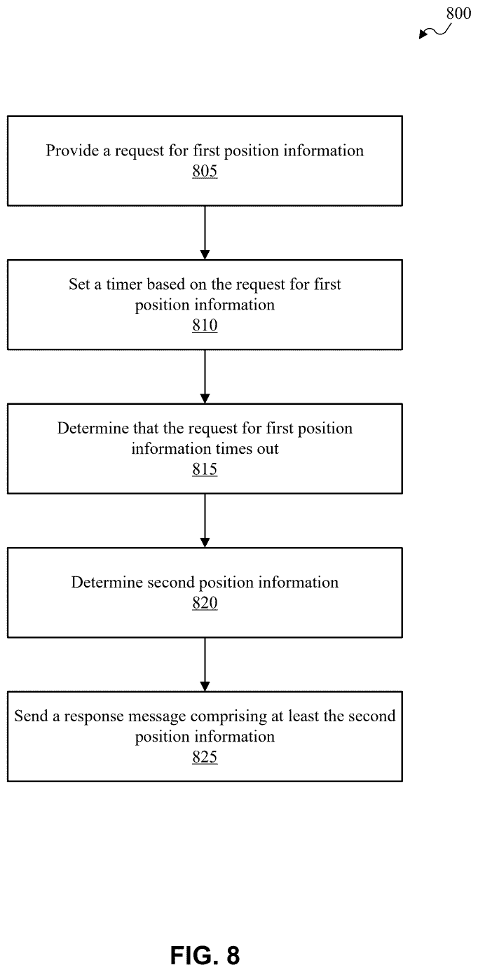

FIG. 8 depicts a flow diagram illustrating an example method 800 associated with the disclosed systems, in accordance with example implementations described herein. In some configurations, one or more aspects of method 800 may be implemented by or in conjunction with modem 140 of FIG. 1 and/or modem 420 of FIG. 4. In some configurations, one or more aspects of method 800 may be implemented by or in conjunction with device 105 of FIG. 1, device 205 or base station 210 of FIG. 2, device 305 or base station 310 of FIG. 3, device 405 or network 410 of FIG. 4, or any combination thereof. The depicted method 800 is just one implementation and one or more operations of method 800 may be rearranged, reordered, omitted, and/or otherwise modified such that other implementations are possible and contemplated.

At 805, method 800 may include provide a request for first position information. For example, a modem (e.g., modem 420) may provide, to an integrated circuit of a UE (e.g., GNSS 445 of device 405), a request for first position information (e.g., AGNSS information) based on the UE receiving a capability request from a core network (e.g., network 410) or from a base station (e.g., base station 310) associated with a core network of the UE.

At 810, method 800 may include setting a timer. For example, the modem may set a timer (e.g., countdown timer, overflow timer) based on sending the request for the first position information to the integrated circuit. In some cases, the modem may send the time value to a core network. For example, the modem may send the time value to a base station. In some cases, the modem may send the time value via an acknowledgement (ACK) message (e.g., an ACK message sent to acknowledge receipt of the location request, ACK 525, ACK 545, and/or ACK 555, etc.).

At 815, method 800 may include determining that the request for first position information times out. For example, the modem may determine that the request for the first position information times out (e.g., expires, overflows) based on the receipt of the first position information remaining in a pending state when the timer expires (e.g., the modem does not receive the first position information before the timer expires or before the timer overflows).

At 820, method 800 may include determining second position information. For example, the modem may determine second position information (e.g., communication-based position information). The second position information may be different from the first position information. In some cases, the modem may determine the second position information based on a location request that requests the first position information and/or the second position information. In some cases, the modem may determine the second position information based on the request for the first position information timing out.

At 825, method 800 may include sending a response message comprising at least the second position information. For example, the modem may send a response message to the core network, where the response message may include the second position information.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of location management based on capability requests, the method comprising:
providing a request for first position information to an integrated circuit of a user equipment (UE) based on a capability request from a base station associated with a core network of the UE;
determining that the request for the first position information fails based on receipt of the first position information being in a pending state after a period of time has passed;
determining, in response to the request for the first position information failing, second position information different from the first position information; and
sending a response message, the response message comprising the second position information.

2. The method of claim 1, further comprising setting the timer based on sending the request for the first position information to the integrated circuit.

3. The method of claim 1, wherein a modem of the UE configures the timer and initiates the timer, the timer being incorporated in the modem.

4. The method of claim 1, wherein the timer is set to a time value that is based on at least one of a default value, a processing capability of a processor of the UE, or a processing capability of the integrated circuit.

5. The method of claim 4, further comprising sending the time value to the base station via an acknowledgement (ACK) message that is sent to acknowledge receipt of the capability request.

6. The method of claim 1, wherein the timer is set to a time value that is based on a first time value associated with the request for the first position information and a second time value associated with a request for the second position information.

7. The method of claim 1, wherein:
the integrated circuit comprises a global navigation satellite system (GNSS) chip of the UE, and
the first position information comprises satellite-based position information.

8. The method of claim 1, wherein the second position information comprises communication-based position information of the UE based on at least one of a time measurement associated with communication of the UE or a signal angle associated with communication of the UE.

9. The method of claim 1, wherein the second position information is based on at least one of enhanced cell ID (ECID), new radio (NR)-ECID, time difference of arrival (TDoA), UL-TDOA, observed time difference of arrival (OTDOA), downlink (DL)-OTDOA, multi-round trip time (multi-RTT), angle of departure (AoD), DL-AOD, angle of arrival, or uplink (UL)-AoA.

10. The method of claim 1, wherein the capability request from the base station is communicated via a non-access stratum (NAS) message and received via a control plane of the UE.

11. A device comprising:
one or more processors; and
memory storing instructions that, when executed by the one or more processors, cause the device to:
provide a request for first position information to an integrated circuit of a user equipment (UE) based on a capability request from a core network of the UE;
determine that the request for the first position information fails based on receipt of the first position information being in a pending state after a period of time has passed;
determine, in response to the request for the first position information failing, second position information different from the first position information; and
send a response message, the response message comprising the second position information.

12. The device of claim 11, wherein the instructions, when executed by the one or more processors, further cause the device to set the timer based on sending the request for the first position information to the integrated circuit.

13. The device of claim 11, wherein a modem of the device configures the timer and initiates the timer, the timer being incorporated in the modem.

14. The device of claim 11, wherein the timer is set to a time value that is based on at least one of a default value, a processing capability of a processor of the device, or a processing capability of the integrated circuit.

15. The device of claim 14, wherein the instructions, when executed by the one or more processors, further cause the device to send the time value to the core network via an acknowledgement (ACK) message that is sent to acknowledge receipt of the capability request.

16. The device of claim 11, wherein the timer is set to a time value that is based on a first time value associated with the request for the first position information and a second time value associated with a request for the second position information.

17. The device of claim 11, wherein:
the integrated circuit comprises a global navigation satellite system (GNSS) chip of the device, and
the first position information comprises satellite-based position information.

18. A non-transitory computer-readable medium storing code that comprises instructions executable by a processor to:
provide a request for first position information to an integrated circuit of a user equipment (UE) based on a capability request from a core network of the UE;
determine that the request for the first position information fails based on receipt of the first position information being in a pending state after a period of time has passed;
determine, in response to the request for the first position information failing, second position information different from the first position information; and
send a response message, the response message comprising the second position information.

19. The non-transitory computer-readable medium of claim 18, wherein the code includes further instructions executable by the processor to set the timer based on sending the request for the first position information to the integrated circuit.

20. The non-transitory computer-readable medium of claim 18, wherein a modem of the UE configures the timer and initiates the timer, the timer being incorporated in the modem.
